(19) United States
(12) Patent Application Publication
(10) Pub. No.: US 2025/0284063 A1
(43) Pub. Date: Sep. 11, 2025

(54) DEPOLARIZER, DEPOLARIZER ADJUSTMENT METHOD, AND DEPOLARIZER MANUFACTURING METHOD

(71) Applicant: FURUKAWA ELECTRIC CO., LTD., Tokyo (JP)

(72) Inventors: Noritaka MATSUBARA, Tokyo (JP); Atsushi KAJI, Tokyo (JP); Kazuya NAGASHIMA, Tokyo (JP)

(73) Assignee: FURUKAWA ELECTRIC CO., LTD., Tokyo (JP)

(21) Appl. No.: 19/214,711

(22) Filed: May 21, 2025

Related U.S. Application Data
(63) Continuation of application No. PCT/JP2023/043727, filed on Dec. 6, 2023.

(30) Foreign Application Priority Data
Dec. 22, 2022 (JP) 2022-205785

(51) Int. Cl. G02B 6/27

(52) U.S. Cl. CPC G02B 6/2786

(57) ABSTRACT

A depolarizer includes: a splitter configured to branch an input light into at least a first light and a second light; a delay applying portion configured to apply a differential group delay with respect to the second light to the first light; a polarization converter configured to convert a polarization state of either the first light or the second light into an orthogonal polarization state; a coupler configured to either multiplex the first light, which has passed through the delay applying portion and the polarization converter, and the second light, or multiplex the first light which has passed through the delay applying portion and the second light which has passed through the polarization converter; and a connecting optical waveguide configured to optically connect the splitter and the coupler.

### CROSS-REFERENCE TO RELATED APPLICATIONS

This application is a continuation of International Application No. PCT/JP2023/043727, filed on Dec. 6, 2023 which claims the benefit of priority of the prior Japanese Patent Application No. 2022-205785, filed on Dec. 22, 2022, the entire contents of which are incorporated herein by reference.

### BACKGROUND OF THE INVENTION

### 1. Field of the Invention

The present disclosure relates to a depolarizer, a depolarizer adjustment method, and a depolarizer manufacturing method.

### 2. Description of the Related Art

A technology has been disclosed about a depolarizer that lowers the degree of polarization of the light input thereto (refer to Japanese Patent Application Laid-open No. H7-159632 and Japanese Patent Application Laid-open No. 2013-152295). In Japanese Patent Application Laid-open No. H7-159632 and Japanese Patent Application Laid-open No. 2013-152295, in a unit that applies a differential group delay (DGD) to the light, or in a splitter that splits the light, or in a coupler that multiplexes the light; a polarization maintaining optical fiber such as a PANDA fiber is used, or an optical waveguide such as a waveguide core included in a planar lightwave circuit (PLC) is used.

### SUMMARY OF THE INVENTION

In some embodiments, a depolarizer includes: a splitter including an optical waveguide, the splitter being configured to branch an input light into at least a first light and a second light to output the first light and the second light; a delay applying portion including optical waveguides including a plurality of curved optical wavelengths, the delay applying portion being configured to apply a differential group delay with respect to the second light to the first light to output the first light having the differential group delay; a polarization converter configured to convert a polarization state of either the first light or the second light into an orthogonal polarization state to output a post-conversion polarization light; a coupler comprising an optical waveguide, the coupler being configured to either multiplex the first light, which has passed through the delay applying portion and the polarization converter, and the second light, or multiplex the first light which has passed through the delay applying portion and the second light which has passed through the polarization converter to output a multiplexed light; and a connecting optical waveguide configured to optically connect the splitter and the coupler to guide the second light, the splitter, the delay applying portion, the polarization converter, the coupler, and the connecting optical waveguide being integrated on a single optical waveguide substrate.

In some embodiments, provided is a depolarizer adjustment method of adjusting the depolarizer. The method includes: inputting a light to the depolarizer; receiving a light that is output from the depolarizer; and adjusting, according to an intensity of the received light, branching either a ratio of the splitter or a multiplexing ratio of the coupler.

In some embodiments, a depolarizer manufacturing method includes: forming a splitter, a delay applying portion, a polarization converter, a coupler, and a connecting optical waveguide; and implementing the depolarizer adjustment method.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a schematic diagram of a depolarizer according to a first embodiment;

FIG. 2 is a schematic diagram of a depolarizer according to a second embodiment;

FIG. 3 is a schematic diagram of a depolarizer according to a third embodiment;

FIG. 4 is a schematic diagram of a depolarizer according to a fourth embodiment;

FIG. 5A is an A-A cross-sectional view in FIG. 4;

FIG. 5B is a B-B cross-sectional view in FIG. 4;

FIG. 5C is a C-C cross-sectional view in FIG. 4;

FIG. 6 is a schematic diagram of a depolarizer according to a fifth embodiment;

FIG. 7 is a schematic diagram of a depolarizer according to a sixth embodiment;

FIG. 8 is a schematic diagram of a depolarizer according to a seventh embodiment;

FIG. 9 is a schematic diagram of a depolarizer according to an eighth embodiment; and

FIG. 10 is a schematic diagram of a depolarizer according to a ninth embodiment.

### DETAILED DESCRIPTION OF THE PREFERRED EMBODIMENTS

Exemplary embodiments are described below with reference to the accompanying drawings. However, the disclosure is not limited by the embodiments described below. In the drawings, identical or corresponding constituent elements are referred to by the same reference numerals, and the same explanation is not repeated. Meanwhile, the drawings are schematic in nature, and it needs to be noted that the relationship among the dimensions of the constituent elements or the proportion of the constituent elements may be different than the actual situation. Among the drawings too, sometimes the relationship among the dimensions and the proportion can be different.

### First Embodiment

### Configuration of Depolarizer

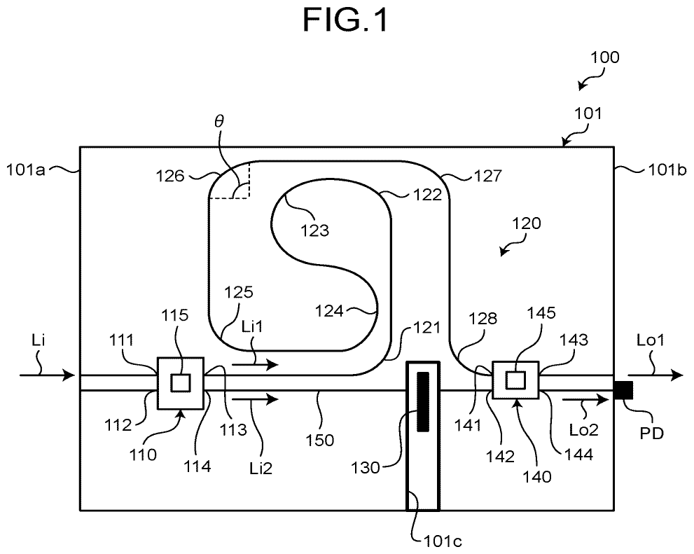

FIG. 1 is a schematic diagram of a depolarizer according to a first embodiment. A depolarizer 100 includes a splitter 110, a delay applying portion 120, a polarization converter 130, a coupler 140, and a connecting optical waveguide 150. The splitter 110, the delay applying portion 120, the polarization converter 130, the coupler 140, and the connecting optical waveguide 150 are integrated on an optical waveguide substrate 101.

The optical waveguide substrate 101 is a planar lightwave circuit (PLC) and includes end faces 101a and 101b positioned opposite to each other. The optical waveguide substrate 101 includes a waveguide core representing an optical waveguide, a cladding that surrounds the waveguide core, and a substrate on the surface of which are formed the optical waveguide and the cladding.

The substrate is, for example, a silicon substrate or a glass substrate. The cladding is made of a silica based glass material. The waveguide core is made of a silica based glass material having a higher refractive index than the refractive index of the cladding. As a silica based glass material having a high refractive index, for example, it is possible to use silica based glass that contains germanium (GeO₂) or zirconia (ZrO₂) as the dopant for enhancing the refractive index. The relative refractive-index difference of the waveguide core with respect to the cladding is, for example, equal to or greater than 0.8%. If the material constituting the waveguide core is, what is called, an SiO₂—ZrO₂-based material represented by a silica based glass containing zirconia, the relative refractive-index difference of the waveguide core with respect to the cladding can be enhanced to be equal to or greater than 4.5%, for example.

The splitter 110 includes an optical waveguide. The splitter 110 includes two input ports 111 and 112, two output ports 113 and 114, and a property adjuster 115. The splitter 110 branches the input light, which is input to the input port 111 or the input port 112, into a first light and a second light having the same polarization state as the polarization state of the input light; and outputs the first light and the second light from the output ports 113 and 114, respectively. The intensity ratio between the first light and the second light, that is, the branching ratio of the splitter 110 is desirably equal to 1:1.

The property adjuster 115 is, for example, a heater formed on the surface of the optical waveguide substrate 101. The property adjuster 115 is capable of heating some part of the optical waveguide constituting the splitter 110, and thus changing the refractive index of that part. As a result, the branching ratio of the splitter 110 can be changed on a permanent basis.

Although there is no particular restriction on the structure of the splitter 110, for example, the splitter 110 has the structure of a Mach-Zehnder interferometer (MZI).

The delay applying portion 120 includes optical waveguides. More specifically, the delay applying portion 120 includes: a plurality of curved optical waveguides 121, 122, 123, 124, 125, 126, 127, and 128; and linear optical waveguides that are disposed in between the curved optical waveguides. The delay applying portion 120 is connected to the output port 113 of the splitter 110.

The coupler 140 includes an optical waveguide. The coupler 140 includes two input ports 141 and 142, two output ports 143 and 144, and a property adjuster 145. The coupler 140 multiplexes the input lights, which are input to the input ports 141 and 142, without changing their polarization states; and outputs the multiplexed light to the two output ports 143 and 144. The multiplexing ratio of the coupler 140 is desirably equal to 1:1. Regarding the ratio of the intensity of the light output from the output port 143 and the intensity of the light output from the output port 144; although there is no particular restriction, the ratio is in the range of 80:20 to 99:1, for example.

The property adjuster 145 is, for example, a heater formed on the surface of the optical waveguide substrate 101. The property adjuster 145 is capable of heating some part of the optical waveguide constituting the coupler 140, and thus changing the refractive index of that part. As a result, the multiplexing ratio of the coupler 140 can be changed on a permanent basis.

Although there is no particular restriction on the structure of the coupler 140, for example, the coupler 140 has the structure of a Mach-Zehnder interferometer (MZI).

On the end face 101b of the optical waveguide substrate 101, an optical receiver PD is disposed to be optically connected to the output port 114. The optical receiver PD is, for example, a photodiode.

The connecting optical waveguide 150 optically connects the output port 114 of the splitter 110 and the input port 142 of the coupler 140.

The polarization converter 130 converts the polarization state of the input light into an orthogonal polarization state that is a polarization state in which a polarization direction is orthogonal to a polarization direction of the input light, and outputs the post-polarization-conversion light. In the first embodiment, the polarization converter 130 is, for example, a filter-type polarization rotating element and is, for example, a half-wave plate. The polarization converter 130 is disposed midway in the connecting optical waveguide 150. More particularly, the polarization converter 130 is inserted into a slit 101c that is formed on the optical waveguide substrate 101 while traversing the connecting optical waveguide 150.

### Operations of Depolarizer

Given below is the explanation of the operations performed when a light Li is input to the depolarizer 100. The following explanation is given about the case in which the light Li has a TE polarization that is a polarization direction parallel to the substrate face of the optical waveguide substrate 101. However, there is no particular restriction on the polarization state of the light Li.

When the light Li is input to the input port 111 of the splitter 110 from the end face 101a of the optical waveguide substrate 101; the splitter 110 branches the light Li into a first light Li1 and a second light Li2, and outputs the first light Li1 from the output port 113 and outputs the second Li2 from the output port 114. The first light Li1 and the second light Li2 have the TE polarization.

The connecting optical waveguide 150 guides the second light Li2. The polarization converter 130, which is disposed midway in the connecting optical waveguide 150, converts the polarization state of the second light Li2 into the orthogonal polarization state, and outputs the post-polarization-conversion light to the remaining part of the connecting optical waveguide 150. More particularly, due to the polarization converter 130, the polarization state of the second light Li2 is converted from the TE polarization to TM polarization that is orthogonal to the TE polarization. The polarization direction of the TM polarization is perpendicular to the substrate face of the optical waveguide substrate 101.

The delay applying portion 120 guides and outputs the first light Li1. At the time of guiding the first light Li1, the delay applying portion 120 applies a differential group delay (DGD) with respect to the second light Li2 to the first light Li1 and outputs the resultant light. As a result, the phase relationship between the first light Li1 and the second light Li2 ceases to exist. In order to eliminate the phase relationship between the first light Li1 and the second light Li2, it is desirable to configure the depolarizer 100 in such a way that the optical path length of the optical waveguide constituting the delay applying portion 120 is longer than the optical path length of the connecting optical waveguide 150 by a length equal to or greater than the coherent length of the light Li. Meanwhile, the first light Li1 that is output from the delay applying portion 120 has TE polarization as the polarization state.

The coupler 140 multiplexes the lights input to the input ports 141 and 142, that is, multiplexes the first light Li1, which has passed through the delay applying portion 120 and which has been applied with the differential group delay (DGD), and the second light Li2, which has passed through the polarization converter 130 and which has been subjected to the conversion of the polarization state; and outputs the multiplexed light as a light Lo1 from the output port 143. The light Lo1 is output from the end face 101b of the depolarizer 100. Thus, the light Lo1 output in this manner is a depolarized light.

The coupler 140 outputs the multiplexed light as a light Lo2 from the output port 144. The light Lo2 too is a depolarized light. The light Lo2 is received by the optical receiver PD. Then, according to the intensity of the received light Lo2, the optical receiver PD outputs an electric signal. The electric signal can be used in, for example, monitoring the optical loss occurring in the depolarizer 100.

In the depolarizer 100 configured in the manner explained above, the splitter 110, the delay applying portion 120, the polarization converter 130, the coupler 140, and the connecting optical waveguide 150 are integrated on the single optical waveguide substrate 101. Hence, it becomes possible to eliminate such connection points at which there occurs deviation in the angle between the polarization principal axes. As a result, in the depolarizer 100, a decline in the properties is held down. Moreover, in the depolarizer 100, since the delay applying portion 120, which applies a differential group delay (DGD), is configured with optical waveguides including a plurality of curved optical waveguides; it becomes easier to make the depolarizer 100 compact.

Moreover, in the depolarizer 100, the splitter 110 includes the two input ports 111 and 112 and includes the two output ports 113 and 114. With reference to FIG. 1, the light Li is input from the input port 111. However, even if the light to be depolarized is input from the input port 112, the depolarizer 100 still functions as a depolarizer. In that regard, the depolarizer 100 can be used in a such a way that, for example, the input port 111 is connected to a particular light source so as to receive input of the light Li from that light source, and the input port 112 is connected to another light source so as to receive input of the light from that other light source. In this way, the depolarizer 100 can be used as a shared depolarizer for two different light sources.

Furthermore, in the depolarizer 100, the coupler 140 includes the two input ports 141 and 142 and includes the two output ports 143 and 144. Hence, one of the two output ports 143 and 144 can be used in monitoring the properties of the depolarizer 100. Particularly, in the depolarizer 100, since the output port 144 is connected to the optical receiver PD, the optical loss occurring in the depolarizer 100 can be monitored according to the intensity of the received light of the optical receiver PD.

As a property of the depolarizer 100, it is desirable that the light Lo1, which is output, has the degree of polarization equal to or smaller than 0.1.

In the depolarizer 100, closer the intensity ratio between the first light Li1 and the Li2, which are multiplexed in the coupler 140, to 1:1, the more excellent are the properties of the depolarizer 100; and, for example, the degree of polarization of the first light Lo1 can be further reduced. Moreover, in the depolarizer 100, closer the polarization states of the first light Li1 and the second light Li2, which are multiplexed in the coupler 140, to the orthogonal state, the more excellent are the properties of the depolarizer 100.

Regarding the first light Li1 and the second light Li2 that are multiplexed in the coupler 140, the reasons for the deviation in the intensity ratio are as follows: the branching ratio of the splitter 110 deviates from 1:1; the optical loss suffered when the first light Li1 is guided is different than the optical loss suffered when the second light Li2 is guided; and the multiplexing ratio of the coupler 140 deviates from 1:1.

In that regard, for example, in the process for manufacturing the depolarizer 100, the branching ratio of the splitter 110 can be changed using the property adjuster 115, and the multiplexing ratio of the coupler 140 can be changed using the property adjuster 145; so that the intensity ratio between the first light Li1 and the second light Li2, which are multiplexed in the coupler 140, can be brought closer to 1:1 and the properties of the depolarizer 100 can be improved.

Meanwhile, regarding the first light Li1 and the second light Li2 that are multiplexed in the coupler 140, the reason for deviation of the polarization state from the orthogonal state is a phenomenon in which there occurs occasional deviation in the polarization states of the curved optical waveguides 121 to 128 included in the delay applying portion 120 (for example, refer to Japanese Patent No. 5959505 and Japanese Patent No. 7042763).

In that regard, in the depolarizer 100, if the sum of the products of the curvature signs and the bending angles of the curved optical waveguides 121 to 128 is equal to zero, it is a desirable condition because of the fact that the deviation in the polarization state is held down. A curvature sign represents the sign of the curvature of a curved optical waveguide. For example, when the guiding direction of the light in a curved optical waveguide is counterclockwise, the curvature sign is positive; and, when the guiding direction is clockwise, the curvature sign is negative. Thus, the curved optical waveguides 121, 122, 123, and 128 have the negative curvature sign, and the curved optical waveguides 124 to 127 have the positive curvature sign. A bending angle represents the angle made by the arc of a curved optical waveguide. In the case of the curved optical waveguide 126, an angle θ represents the bending angle as illustrated in FIG. 1. The angle θ is substantially equal to 90°.

### Second Embodiment

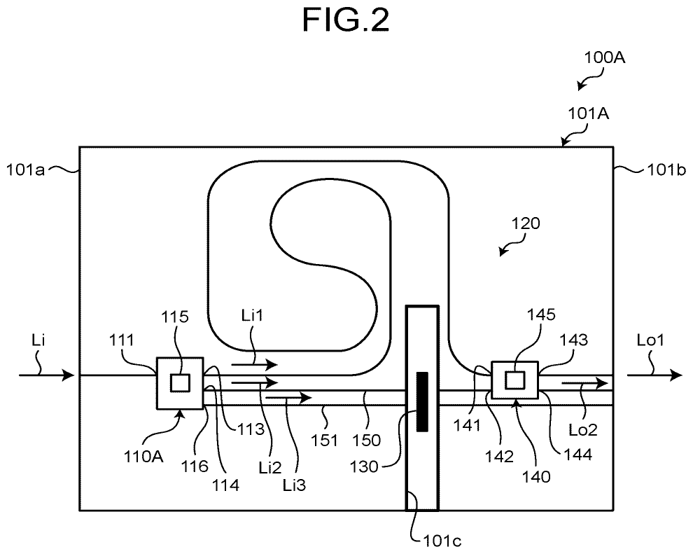

FIG. 2 is a schematic diagram of a depolarizer according to a second embodiment. As compared to the configuration of the depolarizer 100 according to the first embodiment, a depolarizer 100A includes an optical waveguide substrate 101A, which is a PCL, in place of the optical waveguide substrate 101; includes a splitter 110A in place of the splitter 110; and additionally includes a passing-light optical waveguide 151. Meanwhile, the splitter 110A, the delay applying portion 120, the polarization converter 130, the coupler 140, the connecting optical waveguide 150, and the passing-light optical waveguide 151 are integrated on the optical waveguide substrate 101A.

The splitter 110A includes an optical waveguide. The splitter 110A includes a single input port 111; includes three output ports 113, 114, and 116; and includes the property adjuster 115. The splitter 110A branches the input light, which is input to the input port 111, into a first light, a second light, and a third light; and outputs the first light, the second light, and the third light from the three output ports 113, 114, and 116, respectively. The intensity ratio between the first light and the second light, that is, the branching ratio of the splitter 110A regarding the output ports 113 and 114 is desirably equal to 1:1. Regarding the branching ratio of the splitter 110A regarding the output ports 113 and 116; although there is no particular restriction, the branching ratio is in the range of 80:20 to 99:1, for example.

The passing-light optical waveguide 151 is optically connected to the output port 116 of the splitter 110A, and extends up to the end face 101b of the optical waveguide substrate 101A without involving the coupler 140. The passing-light optical waveguide 151 is disposed in such a way that the slit 101c, into which the polarization converter 130 is inserted, traverses the passing-light optical waveguide 151.

Given below is the explanation about the operations performed when the light Li is input to the depolarizer 100A. The following explanation is given about the case in which the light Li includes TE polarization. However, there is no particular restriction on the polarization state of the light Li. When the light Li is input from the end face 101a of the optical waveguide substrate 101A to the input port 111 of the splitter 110A, the splitter 110A branches the light Li into the first light Li1, the second light Li2, and a third light Li3; and outputs the first light Li1, the second light Li2, and the third light Li3 from the three output ports 113, 114, and 116, respectively.

Meanwhile, the connecting optical waveguide 150, the polarization converter 130, the delay applying portion 120, and the coupler 140 perform same operations as the operations performed in the depolarizer 100.

The passing-light optical waveguide 151 causes the third light Li3 to pass through the polarization converter 130 and ensures that the light is output from the end face 101b of the depolarizer 100A without involving the coupler 140.

In an identical manner to the depolarizer 100 according to the first embodiment, in the depolarizer 100A configured in the manner explained above, a decline in the properties is held down and it becomes easier to make the depolarizer 100A compact. Moreover, the output port 144 of the coupler 140 can be used in monitoring the properties of the depolarizer 100A, and the properties of the depolarizer 100A can be improved using the property adjuster 115 and the property adjuster 145.

Moreover, in the depolarizer 100A, the passing-light optical waveguide 151 causes the third light Li3 to pass through the polarization converter 130 and ensures that the light is output from the depolarizer 100A without involving the coupler 140. In that case, as a result of monitoring the light intensity of the third light Li3, it becomes possible to obtain the information regarding the optical loss occurring in the polarization converter 130. The information regarding the optical loss occurring in the polarization converter 130 can be used to know the difference in the optical loss occurring between the path of the first light Li1 and the path of the second light Li2 until the first light Li1 and the second light Li2 are input to the coupler 140 in the depolarizer 100A, and to estimate the properties of the depolarizer 100A.

### Third Embodiment

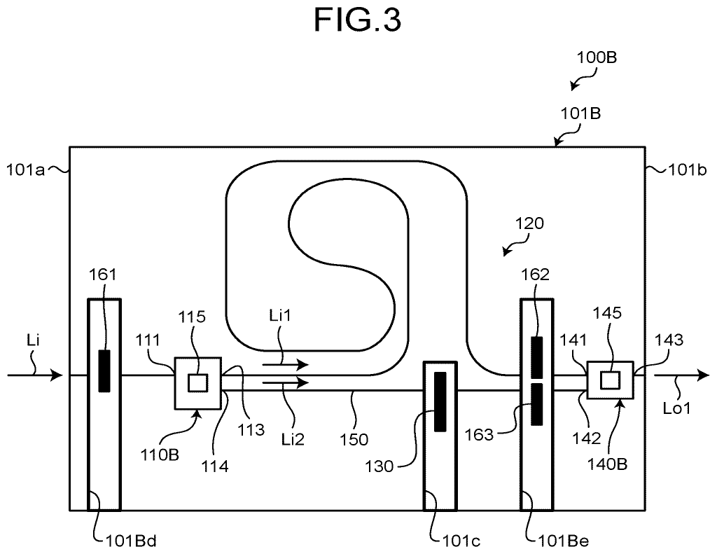

FIG. 3 is a schematic diagram of a depolarizer according to a third embodiment. As compared to the configuration of the depolarizer 100 according to the first embodiment, a depolarizer 100B includes an optical waveguide substrate 101B, which is a PCL, in place of the optical waveguide substrate 101; includes a splitter 110B in place of the splitter 110; includes a coupler 140B in place of the coupler 140; and additionally includes polarizers 161, 162, and 163. Meanwhile, the splitter 110B, the delay applying portion 120, the polarization converter 130, the coupler 140B, the connecting optical waveguide 150, and the polarizers 161, 162, and 163 are integrated on the optical waveguide substrate 101B.

The splitter 110B includes an optical waveguide. The splitter 110B includes a single input port 111; two output ports 113 and 114; and the property adjuster 115. The splitter 110B branches the input light, which is input to the input port 111, into the first light and the second light, and outputs the first light and the second light from the output ports 113 and 114, respectively. The intensity ratio between the first light and the second light, that is, the branching ratio of the splitter 110B regarding the output ports 113 and 114 is desirably equal to 1:1.

The coupler 140B includes an optical waveguide. The coupler 140B includes two input ports 141 and 142; a single output port 143; and the property adjuster 145. The coupler 140B multiplexes the input lights that are input to the input ports 141 and 142, and outputs the multiplexed light from the single output port 143. The branching ratio of the coupler 140 is desirably equal to 1:1.

The polarizer 161 is disposed on an input side of the splitter 110B. For example, the polarizer 161 is disposed in between the end face 101a of the optical waveguide substrate 101B and the input port 111 of the splitter 110B. More particularly, the polarizer 161 is inserted into a slit 101Bd that is formed on the optical waveguide substrate 101B. The polarizer 161 selectively allows passage of the light that has the TE polarization. Thus, the polarizer 161 represents an example of a polarizer that selectively allows passage of the light that has the same linear polarization as the linear polarization of the light input to the splitter 110B.

The polarizer 162 is disposed on an output side of the delay applying portion 120 and on an input side of the coupler 140B. More particularly, the polarizer 162 is inserted into a slit 101B2 that is formed on the optical waveguide substrate 101B. The polarizer 162 selectively allows passage of the light that has the TE polarization. Thus, the polarizer 162 represents an example of a polarizer that selectively allows passage of the light that has the same linear polarization as the linear polarization of the light input to the splitter 110B.

The polarizer 163 is disposed on an output side of the polarization converter 130 and on an input side of the coupler 140B. More particularly, the polarizer 163 is inserted into a slit 101Be. The polarizer 163 selectively allows passage of the light having the TM polarization. Thus, the polarizer 163 represents an example of a polarizer that selectively allows passage of the light that has the linear polarization orthogonal to the linear polarization of the light input to the splitter 110B.

Given below is the explanation of the operations performed when the light Li is input to the depolarizer 100B. The light Li includes the TE polarization representing linear polarization.

When input from the end face 101a of the optical waveguide substrate 101B, the light Li passes through the polarizer 161 and enters the input port 111 of the splitter 110B. The splitter 110B branches the light Li into the first light Li1 and the second light Li2, and outputs the first light Li1 and the second light Li2 from the output ports 113 and 114, respectively.

When the polarization state of the input light Li deviates from the TE polarization, the light Li happens to include the component of the TE polarization and the component of the TM polarization. In that case, when the light Li is input without modification to the splitter 110B, there are times when the depolarizer properties decline as compared to the original properties. In contrast, in the depolarizer 100B, the light Li passes through the polarizer 161 and enters the splitter 110B in the state of having significant attenuation in the component of the TM polarization. Hence, a decline in the properties of the depolarizer 100B is held down.

The connecting optical waveguide 150, the polarization converter 130, and the delay applying portion 120 perform same operations as the operations performed in the depolarizer 100.

The coupler 140B multiplexes the lights input to the input ports 141 and 142, that is, multiplexes the first light Li1, which has passed through the delay applying portion 120 and which has been applied with the differential group delay (DGD), and the second light Li2, which has passed through the polarization converter 130 and which has been subjected to the conversion of the polarization state; and outputs the multiplexed light as the light Lo1 from the output port 143. The light Lo1 is output from the end face 101b of the depolarizer 100B. Thus, the light Lo1 output in this manner is output as a result of depolarization of the light Li.

When the polarization state of the first light Li1 deviates from the TE polarization as a result of being guided by the delay applying portion 120, the first light Li1 happens to include the component of the TE polarization and the component of the TM polarization. In that case, when the first light Li1 is input without modification to the coupler 140B and is multiplexed with the second light Li2, there are times when the depolarizer properties decline as compared to the original properties. In contrast, in the depolarizer 100B, the first light Li1 passes through the polarizer 162 and enters the coupler 140B in the state of having significant attenuation in the component of the TM polarization. Hence, a decline in the properties of the depolarizer 100B is held down.

Moreover, when the polarization state of the second light Li2, which has already passed through the polarization converter 130, deviates from the TM polarization, the first light Li1 happens to include the component of the TM polarization and the component of the TE polarization. In that case, if the second light Li2 is input without modification to the coupler 140B and gets multiplexed with the first light Li1, there are times when the depolarizer properties decline as compared to the original properties. In contrast, in the depolarizer 100B, the second light Li2 passes through the polarizer 163 and enters the coupler 140B in the state of having significant attenuation in the component of the TE polarization. Hence, a decline in the properties of the depolarizer 100B is held down.

In an identical manner to the depolarizer 100 according to the first embodiment, in the depolarizer 100B configured in the manner explained above, a decline in the properties is held down and it becomes easier to make the depolarizer 100B compact. Moreover, the properties of the depolarizer 100B can be improved using the property adjuster 115 and the property adjuster 145.

Furthermore, in the depolarizer 100B, as explained above, a decline in the properties of the depolarizer 100B is held down using the polarizers 161, 162, and 163.

Meanwhile, the depolarizer 100B according to the third embodiment includes the polarizers 161, 162, and 163. However, as long as at least one of the polarizers 161, 162, and 163 is included; it becomes possible to hold down a decline in the properties of the depolarizer 100B.

Moreover, in the depolarizer 100B according to the third embodiment, the input light Li has the TE polarization. Alternatively, if the input light Li has the TM polarization, a depolarizer can be configured in such a way that the polarizers 161 and 162 selectively allow passage of the light having the TM polarization and that the polarizer 163 selectively allows passage of the light having the TE polarization. As a result, a decline in the properties of the depolarizer can be held down in an identical manner.

### Fourth Embodiment

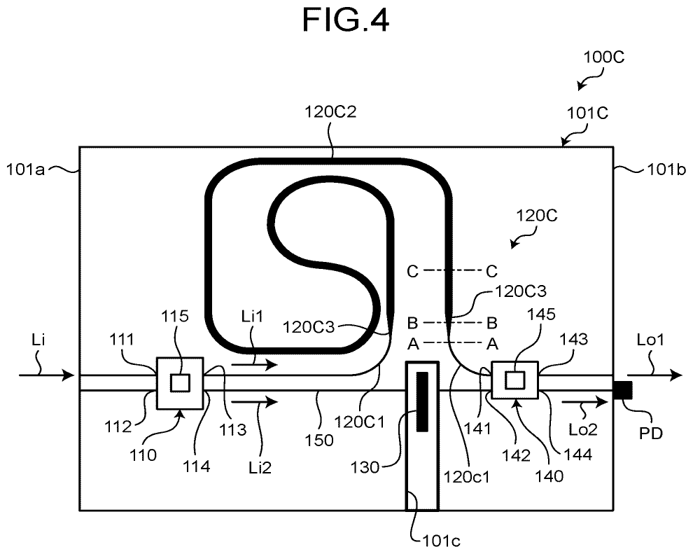

FIG. 4 is a schematic diagram of a depolarizer according to a fourth embodiment. As compared to the configuration of the depolarizer 100 according to the first embodiment, a depolarizer 100C includes an optical waveguide substrate 101C, which is a PCL, in place of the optical waveguide substrate 101; and includes a delay applying portion 120C in place of the delay applying portion 120. Meanwhile, the splitter 110, the delay applying portion 120C, the polarization converter 130, the coupler 140, and the connecting optical waveguide 150 are integrated on the optical waveguide substrate 101C.

The optical waveguides constituting the delay applying portion 120C include a first delay optical waveguide 120C1, a second delay optical waveguide 120C2, and a third delay optical waveguide 120C3.

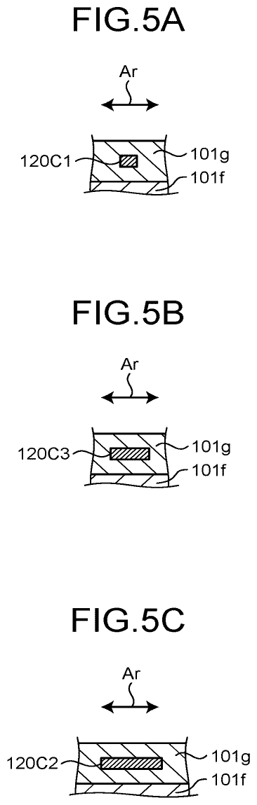

FIGS. 5A to 5C are an A-A cross-sectional view, a B-B cross-sectional view, and a C-C cross-sectional view, respectively, in FIG. 4. More particularly, FIG. 5A is an A-A cross-sectional view, FIG. 5B is a B-B cross-sectional view, and FIG. 5C is a C-C cross-sectional view. In FIGS. 5A to 5C, a substrate 101f, a cladding 101g, the first delay optical waveguide 120C1, the second delay optical waveguide 120C2, and the third delay optical waveguide 120C3 of the optical waveguide substrate 101C are illustrated.

As illustrated in FIGS. 5A and 5C, the waveguide core width representing the width of the second delay optical waveguide 120C2 is greater than the waveguide core width representing the width of the first delay optical waveguide 120C1. As a result, with respect to a light having the TE polarization that has a polarization direction indicated by an arrow Ar, the effective refractive index of the second delay optical waveguide 120C2 is higher than the effective refractive index of the first delay optical waveguide 120C1. For example, the width of the second delay optical waveguide 120C2 is 10 times greater than the width of the first delay optical waveguide 120C1, but can alternatively be greater in the range of twice to 15 times.

As illustrated in FIGS. 4 and 5B, the third delay optical waveguide 120C3 is connected to the first delay optical waveguide 120C1 and the second delay optical waveguide 120C2. The third delay optical waveguide 120C3 has a continuously-changing optical core width. More particularly, from the first delay optical waveguide 120C1 toward the second delay optical waveguide 120C2, the optical core width of the third delay optical waveguide 120C3 continuously increases starting from the optical core width of the first delay optical waveguide 120C1 up to the optical core width of the second delay optical waveguide 120C2.

The splitter 110, the polarization converter 130, the coupler 140, and the connecting optical waveguide 150 have the same configuration as the configuration in the depolarizer 100 and perform same operations as the operations performed in the depolarizer 100.

In an identical manner to the depolarizer 100 according to the first embodiment, in the depolarizer 100C configured in the manner explained above, a decline in the properties is held down; it becomes easier to make the depolarizer 100A compact; the output port 144 of the coupler 140 can be used in monitoring the properties of the depolarizer 100C; and the properties of the depolarizer 100C can be improved using the property adjuster 115 and the property adjuster 145.

Moreover, in the depolarizer 100C, when the polarization state of the first light Li1 that is input to the delay applying portion 120C is TE polarization; a greater differential group delay (DGD) can be applied to the first light Li1 in the second delay optical waveguide 120C2 that has a higher effective refractive index to the first light Li1. As a result, as compared to a delay applying portion that, across the longitudinal direction of the waveguide core width of the optical waveguide constituting that delay applying portion, has the same width as the first delay optical waveguide 120C1; the delay applying portion 120C becomes able to apply a greater differential group delay (DGD) over the same length. In other words, in the case of applying the same differential group delay (DGD), it serves the purpose even when the delay applying portion 120C is shorter, thereby enabling achieving a more compact depolarizer 100C.

Moreover, the depolarizer 100C includes the third delay optical waveguide 120C3, thereby making it possible to hold down an increase in the connection loss occurring between the first delay optical waveguide 120C1 and the second delay optical waveguide 120C2.

In the depolarizer 100C, the width of the second delay optical waveguide 120C2 is greater than the width of the first delay optical waveguide 120C1. Hence, with respect to the light having the TE polarization, the effective refractive index of the second delay optical waveguide 120C2 is set to be greater than the effective refractive index of the first delay optical waveguide 120C1. On the other hand, when the light that is input to the optical waveguide constituting a delay applying portion has the polarization state of TM polarization, by keeping a height of the second delay optical waveguide to be greater than the first delay optical waveguide; with respect to the input light, the effective refractive index of the second delay optical waveguide can be set to be greater than the effective refractive index of the first delay optical waveguide, the height of the second delay optical waveguide being a vertical height from the substrate face of the optical waveguide substrate. Moreover, when the light that is input to the optical waveguide constituting a delay applying portion has the polarization state including TM polarization and TE polarization, by keeping the width and the height of the second delay optical waveguide to be greater than the width and the height of the first delay optical waveguide; with respect to the input light, the effective refractive index of the second delay optical waveguide can be set to be greater than the effective refractive index of the first delay optical waveguide.

Meanwhile, in the delay applying portion 120C too, it is desirable that the sum of the products of the curvature signs and the bending angles of a plurality of curved optical waveguides included in the delay applying portion 120C is equal to zero.

### Fifth Embodiment

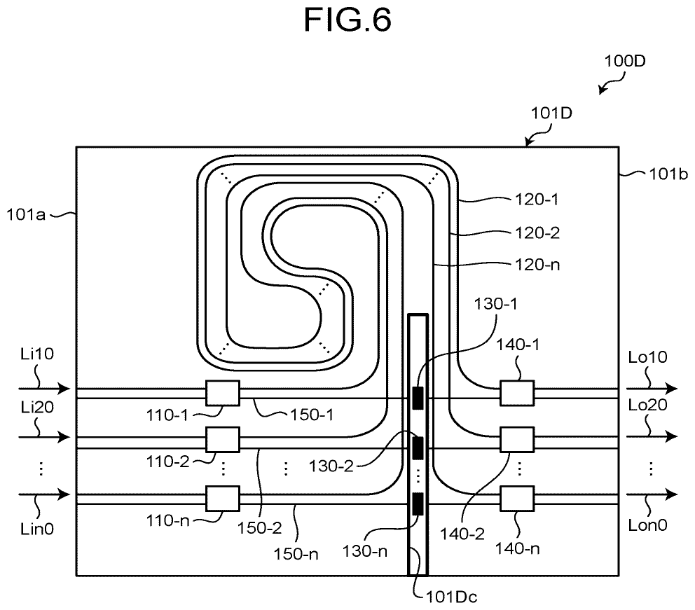

FIG. 6 is a schematic diagram of a depolarizer according to a fifth embodiment. A depolarizer 100D includes a plurality of splitters 110-1, 110-2, . . . , and 110-n; a plurality of delay applying portions 120-1, 120-2, . . . , and 120-n; a plurality of polarization converter 130-1, 130-2, . . . , and 130-n; a plurality of couplers 140-1, 140-2, . . . , and 140-n; and a plurality of connecting optical waveguides 150-1, 150-2, . . . , and 150-n. Herein, for example, “n” is an integer equal to greater than “3”. The splitters 110-1 to 110-n, the delay applying portions 120-1 to 120-n, the polarization converters 130-1 to 130-n, the couplers 140-1 to 140-n, and the connecting optical waveguides 150-1 to 150-n are integrated on an optical waveguide substrate 101D representing a PLC.

The splitters 110-1 to 110-n have an identical configuration and an identical function to the splitter 110. The delay applying portions 120-1 to 120-n have an identical configuration and an identical function to the delay applying portion 120. The polarization converters 130-1 to 130-n have an identical configuration and identical function to the polarization converter 130. The couplers 140-1 to 140-n have an identical configuration and an identical function to the coupler 140. The connecting optical waveguides 150-1 to 150-n have an identical configuration and an identical function to the coupler 140.

The optical waveguides constituting the delay applying portions 120-1 to 120-n are arranged parallel to each other in a curved manner on the optical waveguide substrate 101D.

The polarization converters 130-1 to 130-n are inserted in a slit 101Dc that is formed on the optical waveguide substrate 101D while traversing the connecting optical waveguides 150-1 to 150-n.

The splitter 110-1, the delay applying portion 120-1, the polarization converter 130-1, the coupler 140-1, and the connecting optical waveguide 150-1 are optically connected to each other, and constitute a single unit depolarizer. In an identical manner, each of the remaining splitters, each of the remaining delay applying portions, each of the remaining polarization converters, each of the remaining couplers, and each of the remaining connecting optical waveguides are optically connected to constitute a single unit polarizer. Thus, n number of unit polarizers are integrated on the depolarizer 100D.

In the depolarizer 100D, one of first lights Li10, Li20, . . . , and Lin0 is input to each of the n number of unit depolarizers. Then, each unit depolarizer outputs one of lights Lo10, Lo20, . . . , and Lon0 that are obtained as a result of depolarization of the first lights Li10 to Lin0.

In the depolarizer 100D configured in the manner explained above, each unit depolarizer enables achieving identical effects to the effects achieved in the depolarizer 100 according to the first embodiment. Moreover, as a result of including n number of unit depolarizers, the depolarizer 100D becomes able to depolarize n number of lights in a simultaneous manner. Moreover, if each unit depolarizer is configured as a depolarizer having the properties suitable for a different wavelength band, the depolarizer 100D gets configured to have a wide operating wavelength band. Furthermore, since the optical waveguides constituting the delay applying portions 120-1 to 120-n are arranged parallel to each other in a curved manner, the depolarizer 100D can be configured in a more compact manner despite having n number of unit depolarizers integrated therein.

### Sixth Embodiment

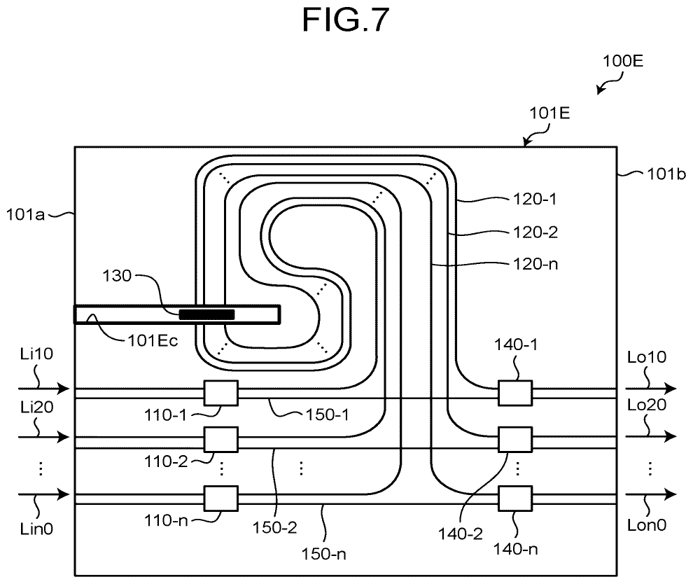

FIG. 7 is a schematic diagram of a depolarizer according to a sixth embodiment. As compared to the configuration of the depolarizer 100D according to the fifth embodiment, a depolarizer 100E includes an optical waveguide substrate 101E, which is a PCL, in place of the optical waveguide substrate 101D; and includes the polarization converter 130 in place of the polarization converters 130-1, 130-2, . . . , and 130-n.

The polarization converter 130 is disposed midway in the optical waveguides constituting the delay applying portions 120-1 to 120-n. More particularly, the polarization converter 130 is inserted in a slit 101Ec that is formed on the optical waveguide substrate 101E while traversing the optical waveguides constituting the delay applying portions 120-1 to 120-n. As a result, the optical waveguides constituting the delay applying portions 120-1 to 120-n are all optically connected to the shared polarization converter 130.

The polarization converter 130 converts the polarization state of the first lights, which are guided by the delay applying portions 120-1 to 120-n, into an orthogonal polarization state, and outputs the post-polarization-conversion lights to the remaining parts of the delay applying portions 120-1 to 120-n.

On the other hand, the second lights that are guided by the connecting optical waveguides 150-1 to 150-n are guided without being subjected to conversion of their polarization state. As a result, each of the couplers 140-1 to 140-n multiplexes a first light and a second light having mutually orthogonal polarization states.

In the depolarizer 100E configured in the manner explained above, it is possible to achieve identical effects to the effects achieved in the depolarizer 100E according to the fifth embodiment. Moreover, in the depolarizer 100E, since the polarization converter 130 is shared, a more compact depolarizer 100E can be achieved as compared to the depolarizer 100D.

### Seventh Embodiment

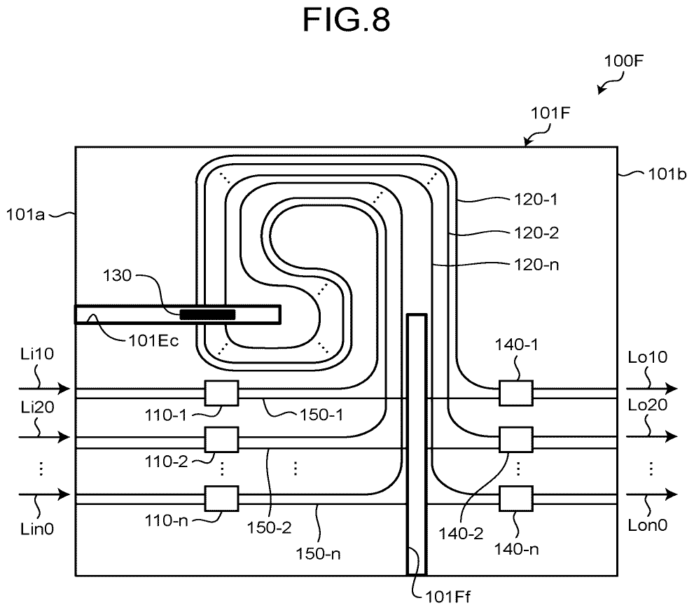

FIG. 8 is a schematic diagram of a depolarizer according to a seventh embodiment. As compared to the configuration of the depolarizer 100D according to the sixth embodiment, a depolarizer 100F includes an optical waveguide substrate 101F, which is a PCL, in place of the optical waveguide substrate 101E, and a slit 101Ff is formed on the optical waveguide substrate 101F.

The slit 101Ff is formed on the optical waveguide substrate 101F while traversing the connecting optical waveguides 150-1 to 150-n. The slit 101Ff represents an example of a second slit. The slit 101Ec represents an example of a first slit.

The depolarizer 100F configured in the manner explained above enables achieving identical effects to the effects achieved in the depolarizer 100E according to the sixth embodiment. In the depolarizer 100F, the slit 101Ec is formed to traverse the optical waveguides constituting the delay applying portions 120-1 to 120-n, and the slit 101Ff is formed to traverse the connecting optical waveguides 150-1 to 150-n. As a result, between the paths of the lights guided by the delay applying portions 120-1 to 120-n and the paths of the lights guided by the connecting optical waveguides 150-1 to 150-n, the optical loss occurring due to the slits either becomes equal to each other or has only a small difference therebetween. Hence, a decline in the depolarizer properties of each unit depolarizer is held down.

Meanwhile, the effects achieved in the configuration in which a slit is formed to traverse the optical waveguides constituting the delay applying portions and in which a slit is formed to traverse the connecting optical waveguides can also be achieved when the configuration is implemented in a depolarizer including only a single unit depolarizer, such as in the depolarizer 100 according to the first embodiment.

In the depolarizer 100F, although the polarization converter is inserted in the first slit, it can be alternatively inserted in the second slit.

### Eighth Embodiment

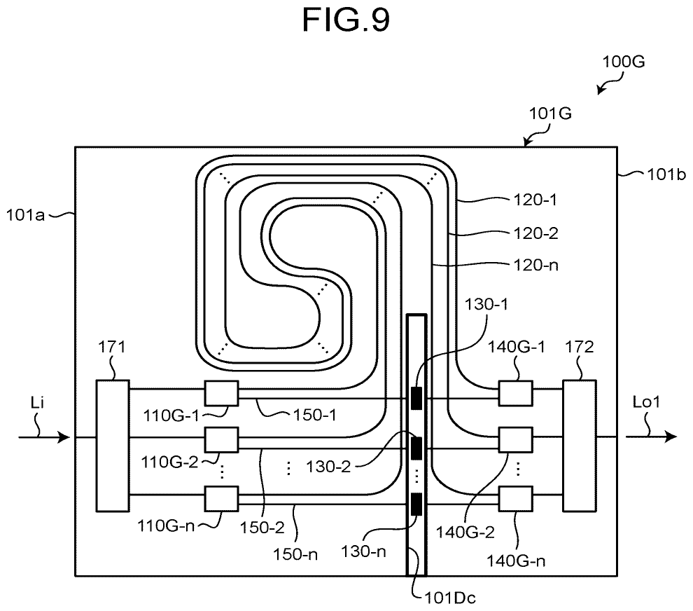

FIG. 9 is a schematic diagram of a depolarizer according to an eighth embodiment. As compared to the configuration of the depolarizer 100D according to the fifth embodiment, a depolarizer 100G includes an optical waveguide substrate 101G, which is a PCL, in place of the optical waveguide substrate 101D; includes splitters 110G-1 to 110G-n in place of the splitters 110-1 to 110-n; includes couplers 140G-1 to 140G-n in place of the couplers 140-1 to 140-n; and additionally includes optical switches 171 and 172. The splitters 110G-1 to 110G-n, the delay applying portions 120-1 to 120-n, the polarization converters 130-1 to 130-n, the couplers 140G-1 to 140G-n, the connecting optical waveguides 150-1 to 150-n, and the optical switches 171 and 172 are integrated on the optical waveguide substrate 101G.

Except for the fact that only a single input port is present, the splitters 110G-1 to 110G-n have an identical configuration and an identical functional to the splitter 110. Moreover, except for the fact that only a single output port is present, the couplers 140G-1 to 140G-n have an identical configuration and an identical function to the coupler 140.

In an identical manner to the depolarizer 100D, the depolarizer 100G includes n number of unit depolarizers.

The optical switch 171 is disposed on an input side of the splitters 110G-1 to 110G-n. The optical switch 171 is switch-controlled so as to output the light that is input to the optical switch 171 to one of the splitters 110G-1 to 110G-n. The optical switch 171 represents an example of an input-side optical switch.

The optical switch 172 is disposed on an output side of the couplers 140G-1 to 140G-n. The optical switch 172 is switch-controlled so as to output the light that is input to the optical switch 172 from one of the couplers 140G-1 to 140G-n. The optical switch 172 represents an example of an output-side optical switch.

The optical switches 171 and 172 includes, for example, a multistage Mach-Zehnder interferometer (MZI) using the optical waveguide.

Given below is the explanation of the operations performed in the depolarizer 100G. When the light Li is input to the depolarizer 100G, the optical switch 171 outputs the light Li, which is input from the end face 101a, to one of the splitters 110G-1 to 110G-n that is selected according to the switch control. The unit depolarizer that includes the splitter to which the light Li is input depolarizes the input light Li, and outputs the depolarized light Lo1 from the coupler included therein to the optical switch 172. Then, the optical switch 172 outputs the light Lo1 from the end face 101b.

The depolarizer 100G configured in the manner explained above enables achieving identical effects to the effects achieved in the depolarizer 100D according to the fifth embodiment. Moreover, when each unit depolarizer is configured as a depolarizer having the properties suitable for a different wavelength band and is connected to a single broadband light source (for example, a wavelength-tunable light source); the depolarizer 100G becomes able to depolarize, without having to repeatedly get linked to the broadband light source, the light that is output from the broadband light source and that has a wide wavelength band.

### Ninth Embodiment

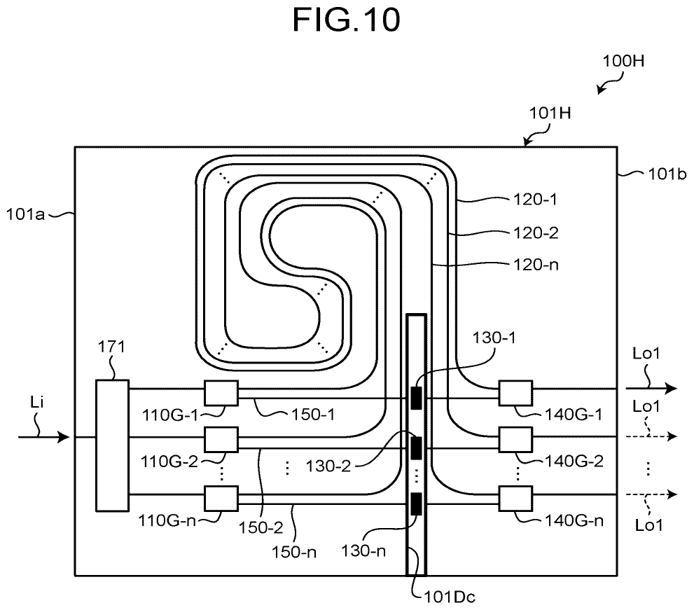

FIG. 10 is a schematic diagram of a depolarizer according to a ninth embodiment. As compared to the configuration of the depolarizer 100G according to the eighth embodiment, a depolarizer 100H includes an optical waveguide substrate 101H, which is a PCL, in place of the optical waveguide substrate 101G; and does not include the optical switch 172. The splitters 110G-1 to 110G-n, the delay applying portions 120-1 to 120-n, the polarization converters 130-1 to 130-n, the couplers 140G-1 to 140G-n, the connecting optical waveguides 150-1 to 150-n, and the optical switch 171 are integrated on the optical waveguide substrate 101H.

In the depolarizer 100H, the input light Li is depolarized in one of the n number of unit depolarizers, and the depolarized light is output from one of the couplers 140G-1 to 140G-n toward the end face 101b.

The depolarizer 100H configured in the manner explained above enables achieving identical effects to the effects achieved in the depolarizer 100D according to the fifth embodiment. Moreover, the depolarizer 100H can change the output destination according to the unit depolarizer used in depolarization. In that case, for example, if each unit polarizer is designed for the properties suitable for a different wavelength band, the output destination can be changed according to the wavelength of the light to be depolarized.

### Depolarizer Adjustment Method and Depolarizer Manufacturing Method

Given below is the explanation about a depolarizer adjustment method of adjusting the properties of the depolarizers according to the embodiments described above. The depolarizer adjustment method includes, for example: inputting a light to a depolarizer; receiving a light output from the depolarizer; and adjusting either a branching ratio of a splitter or a multiplexing ratio of a coupler according to an intensity of a light received by an optical receiver. According to the depolarization adjustment method, even after the waveguide structure of the depolarizer has been formed, it becomes possible to adjust the properties of the depolarizer.

A depolarizer manufacturing method of manufacturing the depolarizers according to the embodiments described above includes, for example: forming a splitter, a delay applying portion, a polarization converter, a camera, and a connecting optical waveguide; and implementing the depolarization adjustment method explained above. According to the depolarizer manufacturing method, even after the waveguide structure of the depolarizer has been formed, it becomes possible to manufacture the depolarizer in the adjusted form.

In the embodiments described above, although the branching ratio of the splitter as well as the multiplexing ratio of the coupler can be changed, it is alternatively possible to keep only one the two ratios variable. Moreover, at least either the splitter or the coupler can include two input ports and two output ports.

In the embodiments described above, a polarization beam combiner (PBC) can be used as the coupler. When a PBC is used as the coupler, two lights having the polarization states in which linear polarizations are orthogonal to each other can be multiplexed at a low loss. Moreover, when a PBC is used as the coupler, multiplexing can be performed while holding down a decline in the degree of polarization of the two lights at the time of multiplexing. As a result, it becomes possible to hold down a decline in the depolarization properties of the depolarizer.

In the embodiments described above, the optical waveguide substrate is a PLC including the optical waveguide made of a glass material. However, the constituent material of the optical waveguide substrate is not limited to a glass material. For example, silicon or silicon nitride can be used as the constituent material of the optical waveguide substrate, or a semiconductor material such as an indium-phosphide-based semiconductor can be used.

Meanwhile, although the disclosure has been described with respect to specific embodiments for a complete and clear disclosure, the appended claims are not to be thus limited. Thus, a configuration obtained by appropriately combining the constituent elements explained above is also included in the disclosure. For example, the configuration of the delay applying portion 120C in the depolarizer 100C according to the fourth embodiment can be implemented in the depolarizers according to the other embodiments. Moreover, the appended claims are to be construed as embodying all modifications and alternative constructions that may occur to one skilled in the art that fairly fall within the basic teaching herein set forth.

According to the disclosure, it becomes possible to obtain a depolarizer in which compactness is achieved with ease and a decline in the properties is held down.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A depolarizer comprising:
a splitter comprising an optical waveguide, the splitter being configured to branch an input light into at least a first light and a second light to output the first light and the second light;
a delay applying portion comprising optical waveguides including a plurality of curved optical wavelengths, the delay applying portion being configured to apply a differential group delay with respect to the second light to the first light to output the first light having the differential group delay;
a polarization converter configured to convert a polarization state of either the first light or the second light into an orthogonal polarization state to output a post-conversion polarization light;
a coupler comprising an optical waveguide, the coupler being configured to either multiplex the first light, which has passed through the delay applying portion and the polarization converter, and the second light, or multiplex the first light which has passed through the delay applying portion and the second light which has passed through the polarization converter to output a multiplexed light; and
a connecting optical waveguide configured to optically connect the splitter and the coupler to guide the second light,
the splitter, the delay applying portion, the polarization converter, the coupler, and the connecting optical waveguide being integrated on a single optical waveguide substrate.

2. The depolarizer according to claim 1, wherein at least either the splitter or the coupler includes two input ports and two output ports.

3. The depolarizer according to claim 1, wherein
the coupler includes two input ports and two output ports, and
one of the two output ports is connected to an optical receiver.

4. The depolarizer according to claim 1, wherein the depolarizer is configured such that at least either a branching ratio of the splitter or a multiplexing ratio of the coupler is variable.

5. The depolarizer according to claim 1, wherein
the splitter includes three output ports, and is configured to branch the input light into the first light, the second light, and a third light to output the first light, the second light, and the third light, and
the depolarizer further includes a passing-light optical waveguide configured to cause the third light to pass through the polarization converter and output the third light from the depolarizer without involving the coupler.

6. The depolarizer according to claim 1, wherein the polarization converter is disposed midway in an optical waveguide constituting the delay applying portion, and is configured to convert the polarization state of the first light into the orthogonal polarization state to output the first light with the orthogonal polarization state.

7. The depolarizer according to claim 1, wherein
the optical waveguide substrate includes a first slit configured to traverse an optical waveguide constituting the delay applying portion, and a second slit configured to traverse the connecting optical waveguide, and
the polarization converter is a polarization rotating element that is inserted into either the first slit or the second slit.

8. The depolarizer according to claim 1, wherein
the splitter is configured to input a light having a first linear polarization, and
the depolarizer further comprises a polarizer that is disposed at least on an input side of the splitter, or on an output side of the delay applying portion and an input side of the coupler, or on an output side of the polarization converter and an input side of the coupler, the polarizer being configured to selectively allow passage of a light having either the first linear polarization or a second linear polarization orthogonal to the first linear polarization.

9. The depolarizer according to claim 1, wherein the coupler is a polarization beam combiner.

10. The depolarizer according to claim 1, wherein the depolarizer is configured such that a sum of products of curvature signs and bending angles of the plurality of curved optical waveguides is equal to zero.

11. The depolarizer according to claim 1, wherein the optical waveguides constituting the delay applying portion include a first delay optical waveguide and a second delay optical waveguide, an effective refractive index of the second delay optical waveguide to an input light being higher than an effective refractive index of the first delay optical waveguide to an input light.

12. The depolarizer according to claim 11, wherein a waveguide core width of the second delay optical waveguide is greater than a waveguide core width of the first delay optical waveguide.

13. The depolarizer according to claim 12, wherein the optical waveguides constituting the delay applying portion include a third delay optical waveguide that connects the first delay optical waveguide and the second delay optical waveguide and that has a continuously-changing optical core width.

14. The depolarizer according to claim 1, wherein
the depolarizer comprises a plurality of sets of the splitter, the delay applying portion, the polarization converter, and the coupler that are optically connected, and
optical waveguides constituting a plurality of delay applying portions are arranged parallel to each other in a curved manner.

15. The depolarizer according to claim 1, wherein
the depolarizer comprises a plurality of sets of the splitter, the delay applying portion, and the coupler that are optically connected,
each set is optically connected in common to the polarization converter, and
optical waveguides constituting a plurality of delay applying portions are arranged parallel to each other in a curved manner.

16. The depolarizer according to claim 14, further comprising an input-side optical switch configured to output a light that is input to the input-side optical switch to one of a plurality of splitters.

17. The depolarizer according to claim 16, further comprising an output-side optical switch configured to output a light that is input to the output-side optical switch from one of a plurality of couplers.

18. A depolarizer adjustment method of adjusting the depolarizer according to claim 1, the method comprising:
inputting a light to the depolarizer;
receiving a light that is output from the depolarizer; and
adjusting, according to an intensity of the received light, branching either a ratio of the splitter or a multiplexing ratio of the coupler.

19. A depolarizer manufacturing method comprising:
forming a splitter, a delay applying portion, a polarization converter, a coupler, and a connecting optical waveguide; and
implementing the depolarizer adjustment method according to claim 18.
